(19) United States
(12) Patent Application Publication
(10) Pub. No.: US 2017/0193157 A1
(43) Pub. Date: Jul. 6, 2017

(54) Testing of Medicinal Drugs and Drug Combinations

(71) Applicant: Microsoft Technology Licensing, LLC, Redmond, WA (US)

(72) Inventors: Christopher B. Quirk, Seattle, WA (US); Wen-tau Yih, Redmond, WA (US); Hoifung Poon, Bellevue, WA (US); Kristina Toutanova, Redmond, WA (US); Stephen William Mayhew, Urbana, IL (US); Sheng Wang, Urbana, IL (US)

(21) Appl. No.: 14/985,023

(22) Filed: Dec. 30, 2015

(51) Int. Cl. G06F 19/12; G06F 19/24; C40B 30/02

(52) U.S. Cl. CPC G06F 19/12; C40B 30/02; G06F 19/24

(57) ABSTRACT

Drug combinations offer promising treatment for some conditions such as cancer. However, the large number of available drug combinations makes it impractical to try all possible combinations. Machine-learning techniques described in this disclosure train a classification algorithm. Once trained, the classification algorithm uses genomic data from a specific patient to perform in silico tests of drugs and drug combinations against the genomic data to determine which therapies are likely to be effective for treating a condition of the specific patient.

### BACKGROUND

Selecting an appropriate treatment from many treatment options is a significant challenge when caring for a patient. It is undesirable to test the efficacy of numerous treatments on the patient. Thus, is desirable to provide clinicians tools and techniques that identify which potential treatments are likely to provide a benefit to a specific patient. In vitro testing is one effective technique for identifying biological response to potential treatments. However, in vitro testing may be impractical to apply on a large scale because of the costs, required time, or limited quantity of biological material to test. In silico testing can be applied on a large scale without the limitations of in vitro testing. Design of a system for in silico testing requires selection of the information to provide to the system and design of the analysis performed by the system.

Machine learning is one technique for creating an in silico testing system. Machine learning explores the study and construction of tools that can learn from and make predictions on data. Machine learning systems operate by building a model from example inputs in order to make data-driven predictions or decisions, rather than following strictly static program instructions.

In silico testing techniques for medicinal drugs and drug combinations have limitations in the predictions they make and the type of knowledge they use. For example, many approaches offer a generic ranking of combinations, and cannot make personalized predictions for individual patients. Others do not leverage genomic data or gene network knowledge and cannot learn from response data of other patients or cell lines. Examples of previous testing techniques include PKIM (Pal, R., Berlow, N.: A kinase inhibition map approach for tumor sensitivity prediction and combination therapy design for targeted drugs. In: Pacific Symposium of Biocomputing (2012)) and TIM (Berlow, N., Davis, L. E., Cantor, E. L., Sguin, B., Keller, C., Pal, R.: A new approach for prediction of tumor sensitivity to targeted drugs based on functional data. BMC Bioinformatics (2013)) which both predict a cell line's response by averaging known responses to medicinal drugs whose targets are a superset of the new drug's target set. In these testing techniques, cell lines take the place of “patients.” The targets in use are selected to minimize leave-one-out errors in the training data. Another technique, TIMMA (Tang, J., Karhinen, L., Xu, T., Szwajda, A., Yadav, B., Wennerberg, K., Aittokallio, T.: Target inhibition networks: Predicting selective combinations of druggable targets to block cancer survival pathways. PLOS Computational Biology (2013)), further improves the accuracy by incorporating response data for medicinal drugs whose target set is a subset rather than superset, and speeds up computation by leveraging efficient implementation of matrix computation. However, none of these approaches makes use of genomic information from the patient or interactions between genes as represented in a gene network. These approaches all require functional data for the same patient or cell line, and do not generalize from data for other patients or cell lines.

### SUMMARY

This Summary is provided to introduce a selection of concepts in a simplified form that are further described below in the Detailed Description. This Summary is not intended to identify key features or essential features of the claimed subject matter nor is it intended to be used to limit the scope of the claimed subject matter.

This disclosure provides a computational tool for in silico testing of drugs and drug combinations to identify candidates that are likely to be effective for treating a condition in a specific patient. The in silico testing uses a machine-learning process that evaluates a set of drugs in view of genomics information from the patient and knowledge obtained from prior classification of the drugs as well as gene relationships represented by a gene network. The genomics information from the patient makes the test personalized and specific to the individual. In one implementation, the genomics information may be a gene expression profile. The set of drugs includes drugs for which drug targets are known. In one implementation, the drug targets are characterized by a binding affinity between the drug and a target protein. The gene network is created by analysis of known relationships between genes. In the gene network, genes may be represented as nodes and relationships between genes may be represented as edges. Downstream drug effects may be represented by connections between genes in the gene network. In one implementation, information for generating the gene network is extracted by machine analysis of scientific literature.

The machine learning process may include training a classifier that tests individual drugs and combinations of drugs against the genomics information of the patient in view of the drug targets and gene network. The classifier may be a binary classifier that classifies the tested drugs and drug combinations as either effective or ineffective for treating a condition of the patient. In one implementation, the classifier may be a linear regression model. However, other classifier models may be used to implement the machine learning process.

### DESCRIPTION OF THE DRAWINGS

The Detailed Description references the accompanying figures. In the figures, the left-most digit(s) of a reference number identifies the figure in which the reference number first appears. The use of the same reference numbers in different figures indicates similar or identical items.

FIG. 1 shows an illustrative schematic for using a machine-learning model as part of a testing process for identifying drugs or drug combinations specifically suited for a given patient.

FIG. 2 shows an illustrative diagram of a computing device implementing a machine-learning model.

FIG. 3 shows an illustrative schematic of the training and use of a machine-learning model for classifying drugs or drug combinations.

FIG. 4 shows an illustrative process for selecting drugs to test in vivo and for administering to a patient.

FIG. 5 shows an illustrative process for creating and using a gene network.

### DETAILED DESCRIPTION

The advent of cheap sequencing technology heralds an era of “precision medicine,” where treatments are tailored for individual diseases to act on specific molecular targets. However, is not yet possible to create new therapeutic molecules for each patient based on an individual's genetic makeup. Thus, a clinician is faced with the task of selecting one or more existing therapeutics for treating a patient. For diseases that have multiple known therapeutics which may be effective, cancer is one example of such a disease, testing each possible therapeutic either on the patient or in vitro may be impractical. Testing all possible combinations of multiple therapeutics may be essentially impossible given current testing constraints. One approach used by clinicians to selects medicinal drug combinations is identifying two or more drugs that have different mechanisms of action. For example, each of the drugs may act on a different protein that has a role in cancer. Another approach is to identify drug combinations is to select two or more drugs that have the same mechanism of action. For example, each of the drugs may act on a different part of the same biochemical pathway. These methods of selecting drugs rely on knowledge of the mechanisms of action of the drugs and educated guesswork but do not directly consider genomics or any other “personal” characteristic of the patient. Selection of drugs to combine because of similar/different mechanism of action is based more on educated guesswork than use of a testing technique.

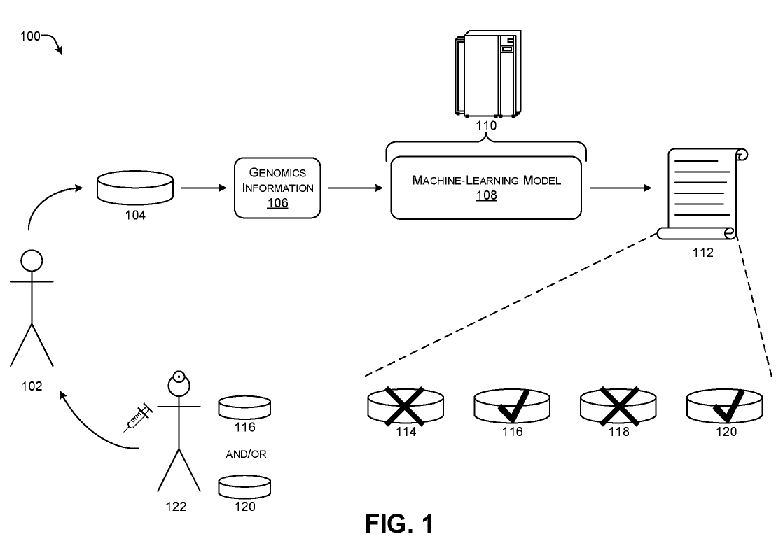

FIG. 1 shows a schematic 100 for using the in silico testing technique of this disclosure to identify treatment options for a patient 102. Biological material 104 is collected from the patient 102 to obtain genomic information 106, which is used to provide a personalized testing technique for the individual patient 102. The biological material 104 may be any material from the patient 102 that contains at least some nucleic acids. For example, the biological material 104 may be blood, saliva, or tissue. In one implementation, the biological material 104 may be taken from a portion of the patient 102 that exhibits a condition. For example, if the condition is cancer, the biological material 104 may be suspected cancerous cells such as cells from a tumor. The biological material 104 may additionally or alternatively be taken from a portion of the patient 102 that is believed to be free of the condition (e.g., noncancerous cells). The biological material 104 may be processed through purification, isolation, cell culture, etc. Persons having ordinary skill in the art will understand how to implement these and other techniques for manipulating biological material 104.

Cell culture is the process by which cells are grown under controlled conditions, generally outside of their natural environment. Cells can be isolated from tissues for ex vivo culture in several ways. Cells can be easily purified from blood; however, only the white cells are capable of growth in culture. Mononuclear cells can be released from soft tissues by enzymatic digestion with enzymes such as collagenase, trypsin, or pronase, which break down the extracellular matrix. Alternatively, pieces of tissue can be placed in growth media, and the cells that grow out are available for culture. This method is known as explant culture. Cells are grown and maintained at an appropriate temperature and gas mixture (typically, 37° C., 5% CO₂ for mammalian cells) in a cell incubator. Culture conditions vary widely for each cell type, and variation of conditions for a particular cell type can result in different phenotypes. Aside from temperature and gas mixture, the most commonly varied factor in culture systems is the cell growth medium. Recipes for growth media can vary in pH, glucose concentration, growth factors, and the presence of other nutrients.

Genomics information 106 is then obtained from the biological material 104. Genomics is a discipline in genetics that applies recombinant DNA, DNA sequencing methods, and bioinformatics to sequence, assemble, and analyze the function and structure of genomes (the complete set of DNA within a single cell of an organism). Selection and use of appropriate techniques for obtaining genomics information 106 from a biological sample 104 are known to those of skill in the art. Genomics also focuses on the dynamic aspects such as gene transcription, translation, and protein-protein interactions, as opposed to the static aspects of the genomic information such as DNA sequence or structures. Genomics attempts to answer questions about the function of DNA at the levels of genes, RNA transcripts, and protein products. Functional genomics studies use a genome-wide approach to answer these questions, generally involving high-throughput methods rather than a more traditional “gene-by-gene” approach.

The genomics information 106 may be stored in encrypted format and protected by password or other security measures to prevent unauthorized access or use. In one implementation, the genomics information 106 may be accessible only to the clinician 122 who is involved in obtaining the genomics information 106.

In one implementation, the genomics information 106 may be gene expression information for one or more cells from the patient 102. Gene expression is the process by which information from a gene is used in the synthesis of a functional gene product. These gene products are often proteins, but in non-protein coding genes such as transfer RNA (tRNA) or small nuclear RNA (snRNA) genes, the product is a functional RNA. In genetics, gene expression is the most fundamental level at which the genotype gives rise to the phenotype, i.e. observable trait. The genetic code stored in DNA is “interpreted” by gene expression, and the properties of the expression give rise to the organism's phenotype. Such phenotypes are often expressed by the synthesis of proteins that control the organism's shape, or that act as enzymes catalyzing specific metabolic pathways characterizing the organism. Several steps in the gene expression process may be modulated, including the transcription, RNA splicing, translation, and post-translational modification of a protein. Gene regulation gives the cell control over structure and function, and is the basis for cellular differentiation, morphogenesis, and the versatility and adaptability of any organism. Gene regulation may also serve as a substrate for evolutionary change, since control of the timing, location, and amount of gene expression can have a profound effect on the functions (actions) of the gene in a cell or in a multicellular organism.

Gene expression profiling is a technique used in molecular biology to query the expression of thousands of genes simultaneously. In the context of cancer, gene expression profiling has been used to classify tumors more accurately. As described above, the biological material 104 may be collected from a portion of the patient that exhibits an effect of the condition such as a tumor exhibiting unregulated cell growth caused by cancer. Many experiments of this sort measure an entire genome simultaneously, that is, every gene present in a particular cell. Expression profiling is a next step after sequencing a genome: the sequence identifies what the cell could possibly do, while the expression profile identifies what it is actually doing at a point in time. Genes contain the instructions for making messenger RNA (mRNA), but at any moment each cell makes mRNA from only a fraction of the genes it carries. If a gene is used to produce mRNA, it is considered “on,” otherwise “off” Many factors determine whether a gene is on or off, such as the time of day, whether or not the cell is actively dividing, its local environment, and chemical signals from other cells. For instance, skin cells, liver cells and nerve cells turn on (express) somewhat different genes and that is in large part what makes them different. Therefore, an expression profile allows one to deduce a cell's type, state, environment, and so forth. The information derived from gene expression profiling may have an impact on predicting the patient's 102 clinical outcome. While almost all cells in an organism contain the entire genome of the organism, only a small subset of those genes is expressed as messenger RNA (mRNA) at any given time, and their relative expression can be evaluated. Techniques include DNA microarray technology or sequenced-based techniques such as serial analysis of gene expression (SAGE).

Current cancer research makes use primarily of DNA microarrays in which an arrayed series of microscopic spots of pre-defined DNA oligonucleotides known as probes are covalently attached to a solid surface such as glass, forming what is known as a gene chip. DNA labeled with fluorophores (target) is prepared from a sample such as a tumor biopsy and is hybridized to the complementary DNA (cDNA) sequences on the gene chip. The chip is then scanned for the presence and strength of the fluorescent labels at each spot representing probe-target hybrids. The level of fluorescence at a particular spot provides quantitative information about the expression of the particular gene corresponding to the spotted cDNA sequence. DNA microarrays evolved from Southern blotting which allows for detection of a specific DNA sequence in a sample of DNA. Microarrays rely on a thorough knowledge of an organism's genome. Such arrays target the identification of known common alleles that represent approximately 500,000 to 2,000,000 SNPs of the more than 10,000,000 in the human genome.

RNA sequencing is becoming more common as a method for cancer gene expression profiling. It is different from microarray techniques due to not having the bias inherent in probe selection. The recent developments of next-generation sequencing (NGS) allow for increased base coverage of a DNA sequence, as well as higher sample throughput. This facilitates sequencing of the RNA transcripts in a cell, providing the ability to look at alternative gene spliced transcripts, post-transcriptional modifications, gene fusion, mutations/SNPs and changes in gene expression. In addition to mRNA transcripts, RNA sequencing can look at different populations of RNA to include total RNA, small RNA, such as miRNA, tRNA, and ribosomal profiling. RNA sequencing can also be used to determine exon/intron boundaries and verify or amend previously annotated 5′ and 3′ gene boundaries. Ongoing RNA sequencing research includes observing cellular pathway alterations during infection and gene-expression-level changes in cancer studies. Persons of ordinary skill in the art will understand how to use the techniques described above to obtain a gene expression profile of the biological material 104.

The genomics information 106 is provided to a machine-learning model 108. The genomics information 106 may be anonymized to remove any personal information that could identify the patient 102 (e.g., metadata including the patient's name). In one implementation, to enhance security and patient privacy, the genomics information 106 may be deleted after it is provided to the machine-learning model 108. Thus, the genomics information 106 will no longer exist as standalone information, but rather it will be integrated into the machine-learning model 108. The machine-learning model 108 may make it difficult or impossible to extract the patient's 102 genomics information 106 from the machine-learning model 108 once the model is created. The machine-learning model 108 is implemented on one or more computing devices 110.

Machine learning is a subfield of computer science that evolved from the study of pattern recognition and computational learning theory in artificial intelligence. Machine learning explores the study and construction of algorithms that can learn from and make predictions on data. The machine-learning model 108 is designed to test a drug or drug combination and classify the drug or drug combinations as either effective or ineffective for treating a given condition in the patient 102. In machine learning and statistics, classification is the problem of identifying to which of a set of categories (sub-populations) a new observation belongs, on the basis of a training set of data containing observations (or instances) whose category membership is known. In the terminology of machine learning, classification is considered an instance of supervised learning, i.e. learning where a training set of correctly identified observations is available. An algorithm that implements classification, especially in a concrete implementation, is known as a classifier. In machine learning, the observations are known as instances, the explanatory variables are termed features (grouped into a feature vector), and the possible categories to be predicted are classes.

In the field of machine learning, the goal of statistical classification is to use an object's characteristics to identify which class (or group) it belongs to. One type of classifier, a linear classifier, achieves this by making a classification decision based on the value of a linear combination of the characteristics. An object's characteristics are also known as feature values and are typically presented to the machine in a vector called a feature vector. Linear classifiers work well for practical problems such as document classification, and more generally for problems with many variables (features), reaching accuracy levels comparable to non-linear classifiers while taking less time to train and use. Examples of linear classifiers that may be used in the machine-learning model 108 include, but are not limited to, Fisher's linear discriminant, Logistic regression, Multinomial logistic regression, Naïve Bayes classifier, Perceptron, and support vector machines (SVM).

The machine-learning model 108 may generate a list of therapeutics 112 that each pass a threshold criteria for effectiveness in affecting a physical parameter associated with the condition of the patient 102 as determined by the machine learning model 108. The therapeutics are generally described as “medical drugs” or “drugs” in this disclosure. Medicinal drugs includes those drugs generally recognized by those of ordinary skill in the art as being intended for use in the diagnosis, cure, mitigation, treatment, or prevention of disease. However, drugs as used herein is not limited to medicinal drugs but also includes any substance such as food, small organic molecules, antibodies, biologics, toxins, etc. that acts on one or more gene targets in the patient 102. The list of therapeutics 112 thus includes all the “drugs” which were tested to be effective by the machine-learning model 108.

Further testing on the identified drugs and drug combinations from the list of therapeutics 112 may be performed in vitro prior to administering a drug or drug combination to the patient 102. The in vitro testing may be designed to test the efficacy of the drug or drug combination on a biological model of the condition from the patient 102. For example, if the condition is cancer, in vitro testing may include growing cancer cells in cell culture and applying different drugs or drug combinations to see which are effective for inhibiting growth of the cancerous cells. Drug efficacy can be estimated by in vitro cancer cell survival upon drug application. Results from multiple drug concentrations can be summarized by activity area (AA), which sums up the percentage of additional cell kill compared to a control. Zero AA signifies a completely ineffective drug, whereas a relatively larger AA signifies relatively higher efficacy.

One measure of in vitro efficacy is IC₅₀. IC₅₀ represents the concentration of a drug or drug combination that is required for 50% inhibition in vitro. It indicates how much of a particular drug or other substance is needed to inhibit a given biological process (or component of a process, i.e. an enzyme, cell, cell receptor, or microorganism) by half. In other words, it is the half minimal (50%) inhibitory concentration (IC) of a substance (50% IC, or IC₅₀). It is commonly used as a measure of antagonist drug potency in pharmacological research. When comparing two drugs or drug combinations, lower IC₅₀ values indicate stronger drug effects because less drug is needed to achieve the same level of inhibition. Sometimes, IC₅₀ is converted to the pIC₅₀ scale (−log IC₅₀), in which higher values indicate exponentially greater potency. Other in vitro test besides cell culture inhibition are known to those having ordinary skill in the art and may be implemented appropriately based on knowledge of the condition of the patient 102 to be treated.

The list of therapeutics 112 may include, for example, for different drugs or drug combinations 114, 116, 118, and 120. Each of these drug or drug combinations have been identified as effective based on the in silico test performed by the machine-learning model 108. However, in vitro testing may indicate that the drug or drug combinations 114 and 118 have relatively low efficacy while the drug or drug combinations 116 and 120 have greater efficacy. Thus, in vitro testing is a further layer of testing to identify a subset of the drugs or drug combinations identified as effective by the machine-learning model 108. One or more of the drugs and drug combinations that pass both the in silico testing and the in vitro testing (e.g., drug or drug combinations 116 and 120) may be administered by a clinician 122 to the patient 102.

Thus, at least two levels of testing may be performed before a drug or drug combination is administered to the patient 102. Out of all possible drugs or combinations of those drugs that are suitable for treating a given condition, each level of testing identifies a subset that satisfies an objective metric of efficacy. This reduces the number drugs or drug combinations to consider for further testing or administration to the patient 102. Instead of performing in vitro testing on hundreds of drugs or drug combinations it may be possible to limit the in vitro testing to only tens of different drugs or drug combinations as a result of the in silico testing. Then as a result of the in vitro testing, the clinician 122 may be able to identify one or only a few drugs or drug combinations that are most likely to be effective for the patient 102. Thus, the techniques described in this disclosure lead to more efficient identification of drugs or drug combinations for administering to the patient 102. These techniques also minimize periods during which the patient 102 may be treated with a drug or drug combination that is less effective than an alternate drug or drug combination.

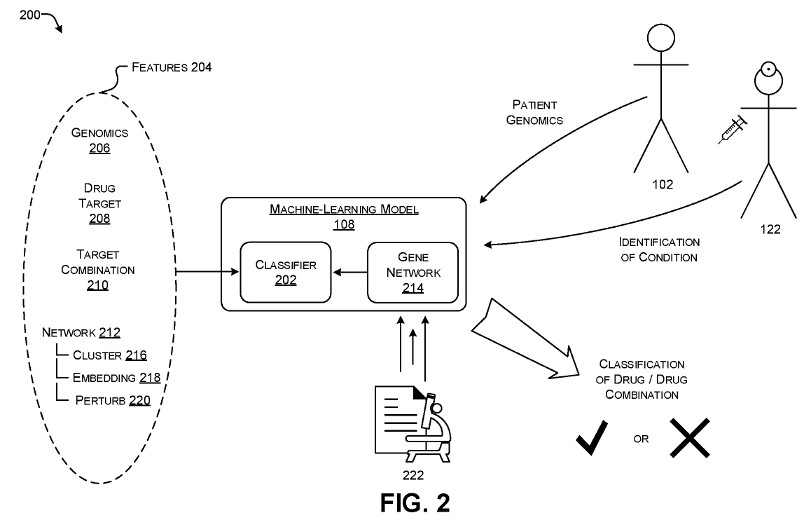

FIG. 2 shows an illustration of inputs and outputs of the machine-learning model 108 from FIG. 1. The machine-learning model 108 includes a classifier 202. In one implementation, the classifier 202 is a linear classifier. In one implementation, the linear classifier is logistic regression. However, other classifiers may be used.

Before the classifier 202 acts on information about drugs, patient genomics, and gene relationships, the problem is formulated in a way that is amenable for applying machine-learning techniques. There are many potential ways of formulating a biological problem so that it can be analyzed using a machine learning technique. The way in which the problem is formulated and represented numerically is itself a part of the inventive contribution provided by this disclosure.

When training the machine-learning model 108, let C={c₁, . . . , cₙ} denote a set of patients, D={d₁, . . . , dₘ} denote a set of drugs (or combinations of drugs), and R=(r(dᵢ, cⱼ) : i, j) denote the response of cⱼ to application of dᵢ. The drugs are assumed to be known drugs. Thus, d's gene targets t(d) are known due to prior work characterizing drug d. The gene targets are genes encoding proteins that the drug d binds to with an affinity above a threshold level (e.g., K_{d}≧100). The set of drugs D may be identified by the clinician 122 either explicitly (e.g., by active selection of a series of individual drugs or groups of drugs for testing) or implicitly (e.g., by identification of a condition of the patient 102 that is correlated to a list of drugs which are known or suspected of being useful for treating the condition). Genomic data e for each individual patient, e(c)=(e(c, g) : g) where g is a gene, is also assumed to be known. In some implementations, the genomics data may be a gene expression profile. This is not the genomics information 106 for the individual patient 102. The set of patients C includes patients that have previously received a drug and have had a response to that drug measured. The “patients” used for training the machine-learning model 108 may be animal models of human disease, cell culture, or other biological objects that can be treated with a drug in order to observe the functional results. Thus, for example, responses of the patients to the drugs may be obtained by treating many different cell cultures with individual ones of the set of drugs D.

Given a training data set up (C, D, R), the classifier 202 learns a function:

f:(t(d),e(c))→r(d,c)

which predicts drug response given gene targets of a drug and genomics information of the multiple patients.

Raw response data from treatment of cell cultures, for example, usually comes as numeric values such as AA or IC₅₀. Genomic data such as gene expression data and drug target data also come in numeric values. For example, RNA-sequence data provides transcript-level normalized log counts. A disassociation constant K_{d} measuring how likely a drug molecule is to separate from a target protein after initial binding is a numerical value that may be used to represent drug targets. Drug targets as used herein include the target proteins and the genes corresponding to those proteins even though the drug molecule does not physically bind to the gene sequences. The disassociation constant may be converted to binding affinity B as follows: B=(M−K_{d})/M, where M=10000 which is the maximum K_{d} value.

Given that numerical response data is available, one way of optimizing the machine-learning model 108 is to modify the model so that it achieves the most accurate predictions of response output for the entire set of drugs. This is the approach is adopted the TIMMA system described above. Specifically, TIMMA optimizes by minimizing the mean squared error. However, this is not the best metric for identifying the top drugs or drug combinations to test further. Because is only feasible to perform further testing, such as in vitro testing, on a limited number of candidates, the in silico testing is best prioritized by identifying the most promising drug candidates. In other words, it is more important to identify correctly the drug or drug combinations that are, based on silico testing, the first second and third best candidates rather than correctly identifying the response caused by the 53^{rd} best candidate. Evaluating a model on mean squared error of response predictions spreads accuracy across the whole set of tested drugs, consequently it is not the best standard to evaluate the accuracy of a testing model for this application. Instead, computational resources are better spent on correctly identifying which candidate drug or drug combinations yield the most favorable in silico test results.

The techniques presented in this disclosure offer an evaluation metric that focuses on identifying the “best” drug candidates rather than minimizing error across the whole set of drug candidates. The machine-learning model 108 represents the response of a patient to a drug as a binary decision: is a given drug or drug combination effective against a given condition within the context of genomic information of the patient? In one implementation, a drug may be defined as effective if raw numeric r values are above a threshold level. For example, if r values are represented numerically as percent of decrease in tumor volume in animal models then effective drugs could be defined as those that reduce tumor volume by 80% or more. The specific threshold level for identifying a response as “effective” may be determined itself by conventional machine-learning techniques, set arbitrarily, or set based on experience. In one implementation, efficacy could be defined as the top 5% of all raw r values.

By treating r as a binary variable (i.e., effective or ineffective), the machine-learning model 108 can be evaluated by comparing calculated r values with r values observed through other testing such as in vitro or in vivo. Thus, possible results for a drug-patient pair, r(d, c), are: r is correctly classified as effective, r is incorrectly classified as effective (false positive), r is correctly classified as ineffective, and r is incorrectly classified as ineffective (false negative). Within this framework, test results can be evaluated for precision and recall. Precision measures the number of correct positive results divided by the number of all positive results; recall measures the number of correct positive results divided by the number of positive results that should have been returned.

Precision and sensitivity can be evaluated together by computing an F₁ score for the results generated by the machine-learning model 108. The F₁ score (also F-score or F-measure) is a measure of a test's accuracy. It calculates the harmonic mean of precision and recall of the test to compute the score. A higher F₁ score indicates a more accurate test. Comparing F₁ scores is one way of comparing the accuracy of different types of testing models.

The classifier 202 uses one or more features 204 (i.e., independent variables) to predict the success of using a drug or combination of drugs to treat a patient. The features that may be considered are genomics 206, drug target 208 which represents drug impacts upon target genes, target combination 210 which represents the collective impact on multiple drug targets based on the target genes co-expression patterns, and network-based features 212 that are based on a model of a gene network 214. The network-based features 212 include cluster 216 that represents drug impacts on a targeted cluster of genes, embedding 218 that represents target gene embedding, and perturb 220 that represents a list of genes for a given patient in the training set which impact is most correlated with drug response.

Genomics 206 may include any type of genomic information from patients C that have been treated by one of the drugs D. For example, genomics 206 may include gene expression, protein synthesis, DNA sequence, epigenetics, RNA sequence, protein sequence, or other information. The genomics 206 feature used for training the classifier 202 are the same type of information as contained in the genomics information 106 from the patient 102. For example, if the classifier 202 is trained with gene expression data then the genomics information 106 is also gene expression data. In one implementation, the genomics 206 feature may be gene expression levels as measured by RNA sequencing. RNA sequencing generates a count of the number of RNA copies sequenced. Thus, each gene may be given a weight based on the count from RNA sequencing. A numerical value for the genomics 206 feature may be the normalized log count from RNA sequencing.

Numerical values generated for genomics 206 feature may be separated by quantiles into multiple equal size groups. The genomics quantiles may be used by the classifier 202 rather than raw numerical values. Each group separated by the quantiles may represent the relative strength of an effect that a drug has on a gene. For example, if the genomics 206 feature is represented as quartiles then the four groups, (e.g., labeled 0, 1, 2, and 3) may represent no effect, minimal effect, moderate effect, and strong effect respectively. Quantization may be done separately for each gene because some genes vary substantially more than other genes.

Drug target 208 indicates the protein and corresponding gene g that are acted on by drug d. The term drug target may refer to the native protein whose activity is modified by a drug resulting in a specific effect, which may be a desirable therapeutic effect or an unwanted adverse effect. In this context, the biological target may be referred to as a drug target. The common drug targets of currently marketed drugs include: proteins, G protein-coupled receptors; enzymes (especially protein kinases, proteases, esterases, and phosphatases); ion channels ligand-gated ion channels; voltage-gated ion channels; nuclear hormone receptors; structural proteins such as tubulin; membrane transport proteins; and nucleic acids. A given drug may, and often does, have multiple targets.

A weight is learned for each potential target gene g with the value GenQuant(g, c)·B(g, d), where GenQuant is the genomics quantile of gene g in patient c (e.g., a value 0-3), and B(g, d) the binding affinity between drug d and the protein encoded by g. Thus, drug target 208 is represented as a single number which is the dot product of the genomics quantile and the drug-gene binding affinity.

Some features 204 incorporate information derived from the gene network 214. These network-based features 212 are cluster 216, embedding 218, and perturb 220. Each of which is explained below.

The gene network 214 is initially created by automated text mining of scientific literature 222. The gene network 214 represents genes as nodes and relationships between two genes as an edge. Persons of ordinary skill in the art will recognize that there are multiple techniques for automatically extracting information from textual documents. For example, one technique is natural language processing.

In one implementation, gene network information may be obtained from the Literome knowledge base. (Poon, H., Quirk, C., DeZiel, C., Heckerman, D.: Literome: Pubmed-scale genomic knowledge base in the cloud. Bioinformatics (2014)). Literome focuses on two types of knowledge most pertinent to genomic medicine: directed genetic interactions such as pathways and genotype-phenotype associations. Genotype refers to either a gene or a single nucleotide polymorphism (SNP). Phenotype refers to the presence of a disease or a drug reaction. An association is a potential correlation between the two.

Users can search Literome for interacting genes and the nature of the interactions, as well as diseases and drugs associated with a SNP or gene. Users can also search for indirect connections between two entities, e.g., a gene and a disease might be linked because an interacting gene is associated with a related disease. Literome is a natural-language processing (NLP) system that automatically extracts biomedical entities and relations from free-text biomedical publication abstracts. Currently, Literome focuses on entities and relations most pertinent to genomic medicine: genes, SNPs, diseases, and drugs, related through genomic interactions (e.g., transcription factors and kinases) and genome-wide associations (e.g., SNP-drug or gene-disease associations). Literome curates directed genetic interactions by extracting transcriptional and regulatory events from text. Each interaction consists of three parts: a type indicating the regulatory direction (positive, negative, or un-specified), a theme that undergoes a specific change (e.g., a gene being transcribed into mRNA, a protein being phosphorylated, etc.), and a cause that brings forth the change (the transcription factor or the kinase). Second, it extracts genotype-phenotype associations from abstracts to curate findings from genome-wide association studies (GWAS).

The relationship between a gene pair, extracted from Literome or another system, may be represented as a triple containing three pieces of information: the gene that regulates, the gene that is regulated, and the type of regulation. Note that this representation also includes direction information by indicating which of the two genes regulates the other. Many genes regulate, and are regulated by, more than one other gene. This series of relationships creates a network between the genes that is the gene network 214.

The gene network 214 may be modified to model downstream impacts of drug targets. Each gene in the gene network 214 may be assigned a reachability probability (Pᵣ) from the other genes in the gene network 214. The reachability probability expresses the likelihood that a drug targeting a first gene will have an effect on a second gene that is not specifically targeted by the drug. If the reachability probability is zero then there is no predicted effect.

In one implementation, the reachability probability for the genes in the gene network 214 may be determined by a random walk that uses a diffusion process to propagate influence through network neighbors. A random walk is a mathematical formalization of a path that consists of a succession of random steps. One application of random walk model is that of a random walk on a regular lattice, where at each step the location jumps to another site according to some probability distribution. For a given drug d, the random walk process may be initiated by assigning all genes g that are targets of the drug a reachability probability Pᵣ that is equal to the binding affinity B of the drug for the gene target. All other genes are assigned a reachability probability of zero. The probability that the effect of a drug remains at the gene without spreading is represented as α. The probability that the effect propagates to a neighboring gene in the gene network 214 is 1−α. A neighboring gene is a gene directly connected by an edge. Thus, the reachability probability for gene g is determined by:

$${P}^{k + 1} ( g ) = a \cdot {P}^{k} ( g ) + ( 1 - a ) \cdot {\sum }_{{g}^{′} ∈ N ( g )} {P}^{k} ( {g}^{′} ) \cdot P ( {g}^{′} \to g )$$

Here N(g) is the set of neighbors of g and P(g′→g) is the transition probability from g′ to g, as determined by the edge weight. The edge weights w may be determined proportion such as, for example, by:

$$\frac{P ( {g}^{′} \to g )}{P ( {g}^{′} \to {g}_{2} )} = \frac{w ( {g}^{′} \to g )}{w ( {g}^{′} \to {g}_{2} )} or \frac{P ( {g}^{′} \to g )}{P ( {g}^{′} \to {g}_{2} )} = \frac{{exp}^{w ( {g}^{′} \to g )}}{{exp}^{w ( {g}^{′} \to {g}_{2} )}} .$$

In one implementation, the edge weight may be uniformly assigned by P(g′→g)=1/N(g′) resulting in the transition probability being uniformly distributed over the neighbors of g′. The random walk process is repeated iteratively k times until the reachability probabilities for the genes in the gene network 214 converge and then (P(g): g) are used in the network-based features 212.

Neural embedding may be applied to the gene network 214 by representing the genes and the relationships between genes as n-dimensional real vectors. Thus, both the nodes and edges in the gene network 214 are changed to vector representations. The vectors are learned by optimizing the scores of the regulation triples extracted from the scientific literature 222. A regulation triple may be represented as (s, r, o) where s represents the regulator gene, r represents the type of regulation, and o represents the regulated gene. A regulation triple in a vector representation, v, may be scored by φ(s, r, o)=v(r)^{τ}(v(s) ∘ v(o)) where ∘ represents the element-wise vector product. (See Toutanova, K., Chen, D., Pantel, P., Poon, H., Choudhury, P., Gamon, M.: Representing text for joint embedding of text and knowledge bases. In: Proceedings of the 2015 Conference on Empirical Methods in Natural Language Processing (2015) for discussion of creating vectors from triples and Yang, B., Yih, W., He, X., Gao, J., Deng, L.: Embedding entities and relations for learning and inference in knowledge bases. In: International Conference on Learning Representations (ICLR) (2015) for discussion of a bilinear model). This creates a vector representation of the genes in the gene network 214 that is based on the information learned from the automated analysis of the scientific literature 222. Next, genes that are inside the gene network 214 are learned and those gene interactions that are inside are a given higher scores than random gene interactions which are not inside the gene network 214. The embedding of genes and interactions determine the score. Interactions inside the network are known, thus embedding that accurately explains in-network interactions is likely a meaningful representation of gene interactions. In contrast, interactions outside of the network are typically random interactions which likely do not correspond to an actual gene interaction. Therefore, higher scores are given to the gene interactions inside the network because these interactions have more predictive power.

Clustering 216 considers the impact a drug may have on a cluster of drug targets 208. Target clusters are formed by grouping together a plurality of drug targets 208 thereby forcing the weight for each drug target in the cluster to be the same. Recall that the drug target 208 may be represented as a single number which is the dot product of the genomics quantile and the drug-gene binding affinity. Any suitable clustering technique including, but not limited to, Gaussian mixture models and hierarchical clustering methods may be used. In one implementation, target clusters are formed by running K-means on the set of potential drug targets 208. The distance for performing K-means clustering may be defined by the shortest path in the gene network 214.

K-means clustering is a method of vector quantization that is used for cluster analysis in data mining and other applications. K-means clustering partitions n observations into k clusters in which each observation belongs to the cluster with the nearest mean, serving as a prototype of the cluster. This results in a partitioning of the data space into Voronoi cells. Given a set of observations (x₁, x₂, . . . , xₙ), where each observation is a d-dimensional real vector, K-means clustering aims to partition the n observations into k (≦n) sets S={S₁, S₂, . . . , Sₖ} so as to minimize the within-cluster sum of squares (WCSS) (sum of distance functions of each point in the cluster to the K center).

In one implementation, the clustering technique may learn a weight for one or more individual target clusters G, with the value of the clustering 216 feature being the average drug impact (Imp) to the cluster represented as:

$$\frac{{\sum }_{g ∈ G} Imp ( g , c , d )}{\vert G \vert}$$

where Imp(g, c, d)=GenQuant(g, c)·Pᵣ(g, d). Recall that Pᵣ represents the reachability probability of a drug target for drug d. Thus, the effects of the gene network 214 are considered in determining the drug impact and therefore in the clustering 216. Without being bound by theory, creating target clusters is believed to provide a way to tie parameters among drug targets 208 and generalized to unseen drug targets using knowledge derived from the gene network 214.

Embedding 218 represents target genes in the gene network 214 as vectors using the neural embedding techniques described above. A weight is learned for each embedding dimension i, with the value of the embedding 218 feature being GenQuant(g, c)·B(g, d)·eᵢ(g), where eᵢ(g)=exp(vᵢ(g))/Z is the normalized exponentiation of the original value v, so that they sum to one for each gene. Without embedding 218, one weight would be learned for each gene target. This could result in a large number of weights if there are a large number of gene targets. With embedding 218, one weight is learned for each dimension rather than target gene. In most applications, there will be many fewer dimensions than gene targets which results in the system learning fewer weights when embedding 218 is used.

Perturb 220 represents a list of genes where drug impact is most correlated with drug response for a given patient. In one implementation, genes are ranked by the Pearson correlation between the known drug response based on experience with a given patient and estimated drug impact Imp(g, c, d). A Pearson correlation coefficient is a measure of the strength of a linear relationship between two variables. The Pearson coefficient can range from −1 to 1. An value of −1 indicates a perfect negative linear relationship between variables, a value of 0 indicates no linear relationship between variables, and a value of 1 indicates a perfect positive linear relationship between variables. Techniques for quantifying a correlation besides Pearson correlation may also be used such as, for example, Spearman's rank correlation coefficient and Kendall's rank correlation coefficient. The top k drug impact values are used as features with a weight for each position. With the perturb 220 feature, gene identity is ignored and this feature represents the degree of perturbation to the patient-specific gene network. The patient-specific gene network is a modification of the general gene network 214 to account for specific gene interactions in the patient 102. For example, the patient 102 may have some genes that are not active so interactions related to the inactive genes will have no effect in the patient 102. Thus, the patient-specific gene network provides additional personalization of the analysis.

Target combination 210 is a feature 204 that represents the collective impact of a drug on a pair of drug targets 208 (g₁, g₂) conditioned on the co-expression patterns of the two drug targets 208. The machine-learning model 108 uses the target combination 210 feature to look for interactions between drug targets to see if there is somehow a different effect when considered together than each of the drug targets individually. If there is no interaction between the drug targets then the result will be the same as modeling each drug separately. The co-expression patterns are based on the quantile values of the genomics 206 data. In one implementation, the group of genomics 206 data representing the strongest and the second strongest effect of a drug on a gene may be used to represent the co-expression patterns. For example, as discussed above, quantization may separate the genomics 206 data into quartiles in which the strongest drug effects is represented by the number 3 and the second strongest drug effects is represented by the number 2. Target combination 210 also considers the reachability probability of the drug target 208 when treated with drug d. Thus, target combination 210 is influenced by the gene network 214 because it considers reachability probability.

For each pair of drug targets, four features 204 may be introduced according to the following four indicator functions:

(1) I[GenQuant(g₁, c)=3 [symbol] GenQuant(g₂, c)=3]·(Pᵣ(g₁, d)+Pᵣ(g₂, d))

(2) I[GenQuant(g₁, c)≧2 [symbol] GenQuant(g₂, c)≧2]·(Pᵣ(g₁, d)+Pᵣ(g₂, d))

(3) I[GenQuant(g₁, c)=3 [symbol] GenQuant(g₂, c)=3]·(Pᵣ(g₁, d)+Pᵣ(g₂, d))

(4) I[GenQuant(g₁, c)≧2 [symbol] GenQuant(g₂, c)≧2]·(Pᵣ(g₁, d)+Pᵣ(g₂, d))

These four features 204 represent the dot product between one of four different co-expression patterns I and a sum of the reachability probability of both of the two drug targets 208. The four different co-expression patterns are: (1) the quantized genomics 206 data for both of the two drug targets 208 exhibit at least the strongest drug effects, (2) the quantized genomics 206 data for both of the two drug targets 208 exhibit at least the second strongest drug effects, (3) the quantized genomics 206 data for either one of the two drug targets 208 exhibits at least the strongest drug effects, and (4) the quantized genomics 206 data for either one of the two drug targets 208 exhibit at least the second strongest drug effects.

The number of possible drug target 208 pairs (g₁, g₂) may be very large given that the set of drugs D may itself be large and that each drug may have several tens of potential targets g. Note that target combination 210 does not distinguish whether a combination of drug targets comes from one drug or from multiple drugs. In this regard, drugs are analyzed as sets of independent drug targets. In one implementation, the target pairs used for evaluating target combination 210 may be initially limited by focusing on target pairs that have certain characteristics. For example, the target pairs may be selected as targets that are the most similar according to the embedding 218 vector values. Alternatively, the target pairs that are the least similar based on the embedding 218 vector values may be selected. Similarity or dissimilarity of two target pairs when represented as vectors may be determined by the dot product of the two vectors (e.g., largest dot products are the most similar, smallest dot products are the least similar).

Once the machine-learning model 108 is trained, it may be provided with genomics information 106 of the patient 102 and identification of a condition that is suspected of affecting the patient 102. The machine-learning model 108 may test some or all of the drug targets g with which it has been trained against the patient's genomics information 106. The machine-learning model 108 identifies drug targets and combinations of drug targets that are classified by the classifier 202 as being effective for affecting a physical parameter associated with the condition in the patient 102. The classifier 202 may, such as when it uses logistic regression, return a probability that a given combination of drug targets will be effective to treat a condition for the patient 102 given that patient's specific genomic profile. The raw output of the classifier 202 may be a number between 0 and 1 (i.e., representing 0-100% probability). The output may be binarized by setting all values equal or above a threshold level (e.g. 0.85 or 85%) as effective and all below the threshold as ineffective. The threshold may be set by conventional optimization techniques or set manually to obtain a desired result.

Note that the machine-learning model 108 operates on the level of drug targets g rather than drugs d. Thus, in many applications the machine-learning model 108 will identify a plurality of drug targets g that are recommended to be acted upon in order to affect a physical parameter associated with the condition. These drug targets g are correlated with one or more of the drugs d resulting in the classification of a drug or combination of drugs as being either effective or ineffective with respect to the physical condition. Thus, when operating at the level of drug targets g the machine-learning model 108 does not explicitly distinguish between a single drug or a combination of multiple drugs.

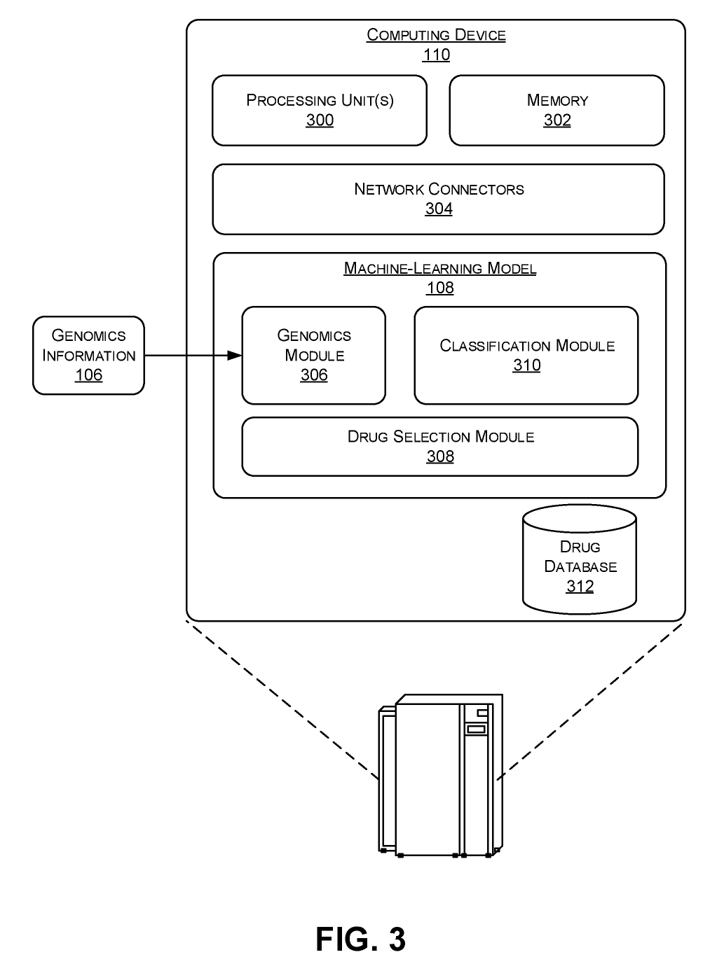

FIG. 3 shows an illustrative diagram of the computing device 110 shown in FIG. 1. The computing device 110 may contain one or more processing unit(s) 300 and memory 302 both of which may be distributed across one or more physical or logical locations. The processing unit(s) 300 may include any combination of central processing units (CPUs), graphical processing units (GPUs), single core processors, multi-core processors, application-specific integrated circuits (ASICs), programmable circuits such as Field Programmable Gate Arrays (FPGA), and the like. One or more of the processing unit(s) 300 may be implemented in software and/or firmware in addition to hardware implementations. Software or firmware implementations of the processing unit(s) 300 may include computer- or machine-executable instructions written in any suitable programming language to perform the various functions described. Software implementations of the processing unit(s) 300 may be stored in whole or part in the memory 302.

Alternatively, or in addition, the functionally of the computing devices 110 can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Computing device 110 may be connected to a network through one or more network connectors 304 for receiving and sending information. The network may be implemented as any type of communications network such as a local area network, a wide area network, a mesh network, and ad hoc network, a peer-to-peer network, the Internet, a cable network, a telephone network, and the like. In one implementation, the computing device 110 may have a direct connection to one or more other devices (e.g. devices that output genomics information 106 in electrical or electronic form) without the presence of an intervening network. The direct connection may be implemented as a wired connection or a wireless connection. A wired connection may include one or more wires or cables physically connecting the computing device 110 to another device. For example, the wired connection may be created by a headphone cable, a telephone cable, a SCSI cable, a USB cable, an Ethernet cable, or the like. The wireless connection may be created by radio frequency (e.g., any version of Bluetooth, ANT, Wi-Fi IEEE 802.11, etc.), infrared light, or the like.

The computing device 110 may be a supercomputer, a network server, a desktop computer, a notebook computer, a collection of server computers such as a server farm, a cloud computing system that uses processing power, memory, and other hardware resources distributed across multiple geographic locations, or the like. The computing device 110 may include one or more input/output components(s) such as a keyboard, a pointing device, a touchscreen, a microphone, a camera, a display, a speaker, a printer, and the like.

Memory 302 of the computing device 110 may include removable storage, non-removable storage, local storage, and/or remote storage to provide storage of computer-readable instructions, data structures, program modules, and other data. The memory 302 may be implemented as computer-readable media. Computer-readable media includes, at least, two types of media, namely computer-readable storage media and communications media. Computer-readable storage media includes volatile and non-volatile, removable and non-removable media implemented in any method or technology for storage of information such as computer-readable instructions, data structures, program modules, or other data. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communications media may embody computer readable instructions, data structures, program modules, or other data in a modulated data signal, such as a carrier wave, or other transmission mechanism. As defined herein, computer-readable storage media and communications media are mutually exclusive.

The computing device 110 includes multiple modules that may be implemented as instructions stored in the memory 302 for execution by processing unit(s) 300 and/or implemented, in whole or in part, by one or more hardware logic components or firmware. The machine-learning model 108 introduced in FIG. 1 is contained within the computing device 110 and may be implemented as instructions stored in the memory 302 for execution by the processing unit(s) 300, by hardware logic components, or both.

A genomics module 306 btains genomics information 106 of the patient from an external source. The genomics information 106 may be obtained from a microarray, next generation sequencer, or other machine connected to the computing device 110 either directly or through the network connectors 304. The genomics information 106 may also be previously saved or stored on a separate computing device or computer-readable media prior to being transferred to the genomics module 306. The genomics information 106 may be partially processed, normalized, rewritten, anonymized, or otherwise modified by the genomics module 306. The genomics module 306 provides the genomics information 106 to a classification module 308. The genomics information 106 may include information from a cell of the patient exhibiting an effect of the condition (e.g., a tumor cell or other cancer cell). In some implementations, the genomics information 106 may include information from a gene expression profile.

A drug selection module 308 identifies a plurality of drugs to the classification module 310 for testing. Information about the plurality of drugs may be obtained from a drug database 312. The drug database 312 may include information such as drug names, drug indications, conditions for which the drugs are intended to treat, side effects, known interactions with other drugs, drug targets, and the like. In one implementation, the drug-selection module 308 may respond to input from a clinician or other user manually indicating a set of specific drugs to test. In one implementation, the drug-selection module 308 may select drugs automatically or semi-automatically based at least in part on an indication of a condition of the patient, an indication of a drug formulary (e.g., provided by an insurance company or the like), or the like.

One implementation, the plurality of drugs may be represented as a plurality of drug targets. As mentioned above, the drug target information may be available from the drug database 312.l Individual ones of the plurality of drug targets may indicate a target and a disassociation constant (K_{d}) between the drug and the target.

The classification module 310 identifies one or more drugs from the plurality of drugs provided by the drug selection module 308 that have more than a threshold probability of affecting at least one physical parameter associated with a condition in the patient. The classification module 310 bases the identification at least in part on the genomics information from the patient. The condition may be anemia, cancer, asthma, heart disease, type II diabetes, or any other disease or ailment. Each condition has accepted clinical symptoms associated with diagnoses and treatments that are known to those having ordinary skill in the art. The physical parameter associated with the condition that can be affected by drugs will vary by condition but may include any clinical symptom associated with diagnosis or treatment of the condition. The test results may be presented as the list of therapeutics 112 shown in FIG. 1.

In one implementation, the classification module 310 may learn a classifier from a combination of a gene network, functional effects of at least one drug from the plurality of drugs on a previously-treated patient, and genomics information from the previously-treated patient. In one implementation, the classification module 310 may use logistic regression to classify drugs or drug combinations as effective or ineffective. The gene network may be the gene network 214 shown in FIG. 2. The functional effects of a drug on a previously treated patient indicate whether and to what extent the drug was effective in treating the patient. When the patient is a model such as an in vitro model like a cell culture, functional effects may be measured by AA or other metric appropriate for the model. The genomics information from the previously treated patient may be the genomics feature 206 shown in FIG. 2.

### Illustrative Processes

For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process, or an alternate process. Moreover, it is also possible that one or more of the provided operations is modified or omitted.

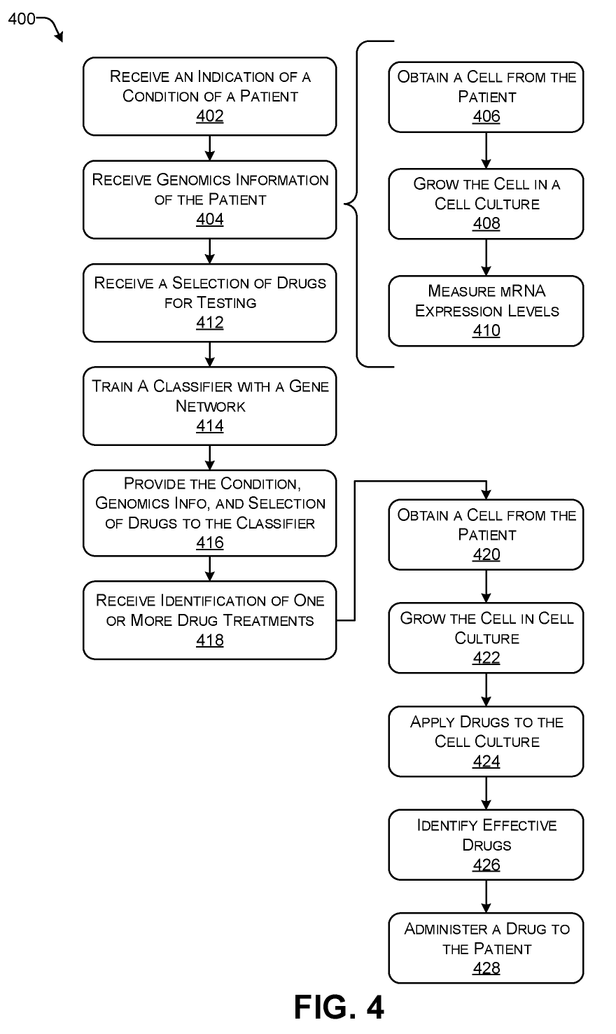

FIG. 4 shows an illustrative process 400 for selecting drugs to administer to a patient. The selection process includes in silico testing and may also include in vitro testing.

At 402, an indication of a condition of the patient is received. The condition may be identification of a disease, ailment, pathology, etc. which the patient has been diagnosed as having or which the patient is suspected of having. The indication of the condition may be received from the clinician 122 as shown in FIG. 2.

At 404, genomics information of the patient is received. The genomics information may include a gene expression profile of a cell from the patient. The genomics information may be the same as the genomics information 106 shown in FIG. 1. In some implementations, at least part of the genomics information may be generated by performing acts such as those described in 406, 408, and 410.

At 406, a cell exhibiting the condition is obtained from the patient. The cell may be obtained by a biopsy, cheek swab, blood draw, hair follicle, or other suitable technique.

At 408, the cell is grown in a cell culture. The cell culture may be the same as the biological material 104 shown in FIG. 1.

At 410, mRNA expression levels of the cell culture are measured. As discussed above, the mRNA expression levels may be measured by RNA sequencing, micro arrays, or other techniques. The mRNA expression levels may be used as all or part of the genomics information of the patient.

At 412, a selection of a plurality of drugs is received for in silico testing. The plurality of drugs may be manually selected by a clinician or other individual. The plurality of drugs may be selected in part based on the indication of the condition of the patient. For example, if the indication is that the patient has type II diabetes, the plurality of drugs may be drugs that are known to be used for treating type II diabetes.

At 414, a classifier trained with supervised learning is trained at least in part by a gene network in which individual genes in the gene network are represented as n-dimensional vectors. The gene network may be the same as gene network 214 shown in FIG. 2. In some implementations, the classifier is a linear classifier that classifiers individual drugs or combinations of drugs from the plurality of drugs as either effective or ineffective for affecting at least one physical parameter associated with the condition in the patient. The classifier may be the same as classifier 202 shown in FIG. 2.

At 416, the condition of the patient, the genomics information, and the selection of the plurality of drugs are provided to the classifier to perform the in silico testing.

At 418, one or more drug treatments selected from the plurality of drugs is received from the classifier. Individual ones of the one or more drug treatments may be a single drug or may alternatively be a multiple drug combination. In one implementation, a plurality of drug targets is received from the classifier. The drug targets may be the same as drug target 208 shown in FIG. 2. The plurality of drug targets may then be mapped to the one or more drug treatments based on knowledge of drug targets for individual drugs in the drug treatments. Thus, the drugs themselves may be selected based on the drug targets on which the drugs act. In one implementation, the one or more drug treatments may include at least two drug treatments ordered by a probability of affecting the condition of the patient. The one or more drug treatments may be provided in a list such as the list of therapeutics 112 shown in FIG. 1. The probability of affecting the condition of the patient may be a probability returned by the classifier. Thus, there may be a numerical ranking among the potential drug treatments even though all of the potential drug treatments are classified as likely to be effective. For example, a first drug combination may have a 0.90 probability of being effective and a second drug combination may have a 0.95probability of being effective. Both the first drug combination and the second drug combination are classified as effective and if ranked, the second drug combination has a higher rank than the first drug combination because it is associated with a higher probability.

At 420, a cell exhibiting the condition is obtained from the patient. The cell may be obtained by a biopsy, cheek swab, blood draw, hair follicle, or other suitable technique.

At 422, the cell is grown in a cell culture. The cell culture may be the same as the biological material 104 shown in FIG. 1.

At 424, at least two of the drug treatments are applied separately to the cell culture. This provides in vitro testing in addition to the in silico testing performed earlier.

At 426, one or more of the drug treatments that were applied to the cell culture are identified as affecting the cell culture. Effects of the drug treatments on the cell culture may be observed and used to determine which of the drug treatments is more effective than the other based on an in vitro test. If a desired effect of the drug is to kill cells such as cancer cells, then AA may be used to evaluate the effects of the drug treatments on the cell culture. Thus, some number of drug treatments are further identified as effective by testing on the cell cultures. Identifying cell cultures affected by drug treatments is shown in 114-120 of FIG. 1.

At 428, at least one drug treatment identified as affecting the cell culture is administered to the patient. Thus, the drug treatment that is ultimately administered to the patient has been identified as likely to be effective by both in silico testing and in vitro testing. FIG. 1 shows clinician 122 administering one or both of the drugs/drug combinations 116 and 122 to the patient 102.

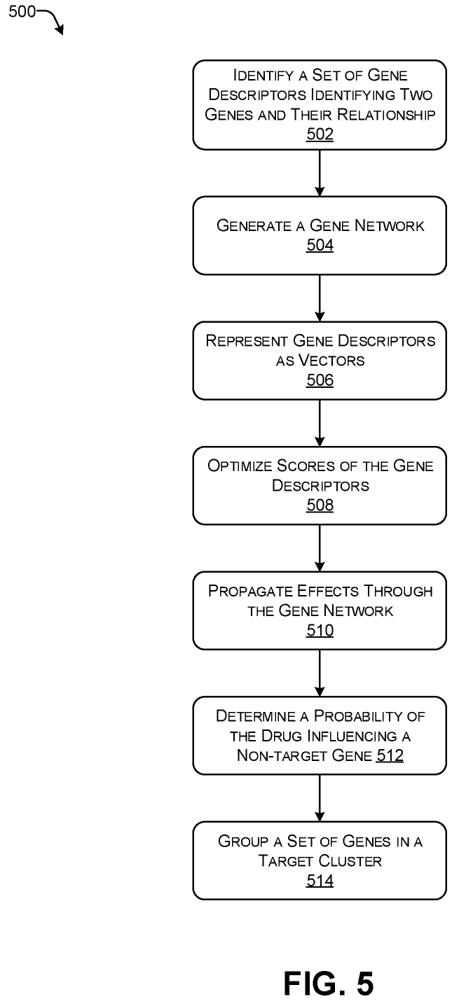

FIG. 5 shows an illustrative process 500 for identifying a downstream effect of a drug on genes that are not direct targets of the drug. This is done by creating a gene network and then observing how genes in the network affect each other. The gene network may be the same as a gene network 214 shown in FIG. 2.

At 502, a set of gene descriptors are identified. The gene descriptors identify a first gene, a second gene, the type of influence between the first gene and the second gene, and a direction of influence. In one implementation, the set of gene descriptors are identified at least in part from natural language processing of scientific literature. The scientific literature may be the scientific literature 222 shown in FIG. 2.

At 504, the gene network is generated. The gene network includes the first gene, the second gene, and a plurality of other genes. In some instances, the gene network will include hundreds or thousands of genes. Individual genes in the gene network are represented by nodes and relationships between individual genes represented by edges.

At 506, information contained in the gene descriptors are represented as a plurality of n-dimensional real vectors.

At 508, scores of the gene descriptors are optimized such that gene descriptors that are in the gene network have higher scores than gene descriptors that are outside the gene network.

At 510, an effect of the drug on a target gene is propagated through the edges of the gene network from the target gene to one or more other genes that are not direct targets of the drug. This represents how changes in one gene due to the drug affect other genes. For example, if gene A is down regulated by drug 1, and down regulation of gene A leads to up regulation of gene B, then up regulation of gene B is a network effect of drug 1.

At 512, a probability of the drug influence the gene that is not the direct target of the drug is determined. Returning to the example above, this is the probability of drug 1 influencing gene B. In one implementation, the probability of the drug influencing the gene that is not the direct target of the drug is determined at least in part by iteratively simulating a random walk process through the gene network.

At 514, a set of genes is grouped in a target cluster based at least in part on a shortest path in the gene network between the set of genes. This grouping is used for the target combination 210 feature shown in FIG. 2.

### EXAMPLES

Accuracy of this machine-learning model was tested using a standard dataset available from the Cancer Cell Line Encyclopedia (CCLE data set). (See Barretina, J., Caponigro, G., Stransky, N., Venkatesan, K., Margolin, A. A., et al.: The cancer cell line encyclopedia enables predictive modelling of anticancer drug sensitivity. Nature (2012)). The CCLE dataset includes functional results for 504 cell lines and 24 drugs. The cell lines were each stared from cancerous cells taken from human patients. Thus, applying drugs to one of the cell lines is analogous to in vitro testing on a cell line created from a tumor or other cancerous cells in a patient. Drug response is summarized by activity area (AA) which averages percentage of cell kill compared to control, under various dosages. The genomics information is available for each cell line, including RNA expression data. The test evaluated 12 drugs with target information (the remaining 12 drugs are generic chemotherapy drugs without specific drug targets). Thus, in this test the condition is cancer, the set of drugs is 12 anticancer drugs, and the patients for the purposes of training the machine-learning model are cell cultures of the 504 cell lines. The challenge of testing drug combinations other than with in silico techniques is apparent even from this small sample. For 12 drugs there are 66 unique two-drug combinations and 222 unique three-drug combinations. This number of drug combinations would be impractical to test in vitro or in vivo.

There are 299 drug targets between the 12 drugs evaluated in the CCLE dataset. Many of the drug targets are targeted by more than one of the 12 different drugs. On average, a single one of the drugs has 76 different drug targets. The drug targets are known due to prior research on the drugs. The disassociation constant of the drugs is also known and used to compute binding affinity for drug-gene pairs. (For the disassociation constants see Tang, J., Karhinen, L., Xu, T., Szwajda, A., Yadav, B., Wennerberg, K., Aittokallio, T.: Target inhibition networks: Predicting selective combinations of druggable targets to block cancer survival pathways. PLOS Computational Biology (2013)). Out of the 299 drug targets, 141 had K_{d} of at least 100. However, the average K_{d} was only 14.

Information to create the gene network was obtained from the Literome knowledge base using data current as of September 2015. This knowledge base contains pathway knowledge extracted from over 320,000 PubMed® articles. Information from the knowledge base was converted into regulation triples. The regulation triples identify a first gene, a second gene, and a type of regulation (e.g., inhibition, promotion, etc.). The direction of the influence is indicated by the ordering of the regulation triple. For example, “gene 1 inhibits gene 2” is a regulation triple. The Literome knowledge base used for these experiments contains 15,692 genes and 1,579,370 regulation triples. These regulation triples are the basis of the gene network.

Comparative testing was performed between the TIMMA system described above (representative of a comparative technique), patient average response (representative of a simple metric for personalized drug responsiveness), and multiple variations of the testing techniques presented in this disclosure. The TIMMA system was modified to create leave-one-out training sets in which the training portion only involves drugs other than the test drug. The TIMMA system, as published, used some information from the tested drug in designing the test, thus it is not a true leave-one-out analysis of the CCLE dataset.

The goal is to identify test accuracy when evaluating a patient for which the result is unknown. Because the functional results for all of the drugs and cell lines in the CCLE dataset are known, leave-one-out training sets simulate a drug with unknown effects by using, in this example, only 11 out of the 12 drugs for training then the testing is performed for the 12th drug. This was repeated for each of the 12 drugs so there were 12 different training sets each using a different combination of 11 drugs.

The patient average represents the average drug response for each patient (i.e., cell line) and uses a simple average as the predicted effect for the unseen drug. Thus, the average AA for 11 of the 12 drugs is used as the predicted AA for the 12^{th} drug.

For the techniques disclosed herein, recall that there are multiple features of which any one, any combination, or all may be used for training the classifier algorithm. Different individual features and combinations of features were used to train the classifier resulting in six different variations of the machine-learning model of this disclosure. The variations assess which features are useful for improving the accuracy of the machine-learning model. Use of different combinations of features is a way to evaluate the respective predictive effect of genomics information, the gene network, and modeling of target combinations. Standard logistic regression with L₂ prior of 1 was used for classification. For the cluster 216 feature, K-means was used to create 20 clusters. For the embedding 218 feature, there were 20 embedding dimensions. For the perturb 220 feature, the top five drug impact values most correlated with drug response were used. For the target combination 210 feature, the top 500 most similar drug target pairs were used.

To compare each of the different testing techniques, a threshold was applied to binarize probability results into yes-effective treatment or no-not effective treatment. The threshold was selected by conventional techniques for optimization training. Once converted to binary results, and because the true results from the CCLE dataset are known, it was possible to determine precision, recall, and F₁ for each of the 12 tested drugs for each tested system. The results presented in Table 1 below present the average precision, recall, and F₁ values for each of the 12 tested drugs.

TABLE 1
Comparison of TIMMA, patient-average baseline, and different
variations of the machine-learning model of this disclosure.

| | Avg. | Avg. | Avg. |
|---|---|---|---|
| System | Precision | Recall | F₁ |
| TIMMA | 20.6 | 22.1 | 12.8 |
| Patient Average | 18.0 | 55.5 | 16.9 |
| Genomics | 18.0 | 55.5 | 17.0 |
| Drug Target (DT) | 17.0 | 39.1 | 17.6 |
| DT + Genomics | 17.0 | 39.9 | 17.9 |
| DT + Genomics + Network | 20.9 | 40.1 | 20.9 |
| Target Combination + Genomics | 37.7 | 26.0 | 23.7 |
| Target Combo. + Genomics + Network | 42.2 | 24.2 | 25.2 |

The test results show that analyzing the drug targets as clusters and training the classifier with both genomics features and network features produces the most accurate results as shown by the highest F₁ value of 25.2. This is over twice the F₁ value of the comparative TIMMA system. The mean squared error for the TIMMA system across all CCLE cell lines is 0.11 but that bears little indication on how well the TIMMA system can identify candidates with top efficacy. This may be because the mean squared error emphasizes optimizing across all candidates even the ineffective ones.

The simple patient average metric provided better F₁ results than the TIMMA system. Patent average and TIMMA both require knowledge of how the tested patient (cell line) responds to other drugs. In contrast, the machine-learning models described in this disclosure and shown in Table 1 do not require explicit knowledge of drug response for the tested patient. Instead, the machine-learning models described herein use analysis of multiple drug targets from multiple drugs and, in some variations, consider gene network effects.

The variations of the machine-learning model from this disclosure show that consideration of drug targets has a larger effect on F₁ than does consideration of genomics. Addition of network features lead to further increases in F₁. Interestingly, using the target combination feature instead of the drug target feature provided a large benefit. The design of the target combination feature in these tests considers target pairs with similar embedding. Thus, the two genes in a target pair are likely to share similar regulatory neighbors and therefore to be in the same pathway. Therefore, without being bound by theory, drugs may achieve synergistic effects by targeting different aspects of the same pathway.

### Illustrative Embodiments

The following clauses described multiple possible embodiments for implementing the features described in this disclosure. The various embodiments described herein are not limiting nor is every feature from any given embodiment required to be present in another embodiment. Any two or more of the embodiments may be combined together unless context clearly indicates otherwise. As used herein in this document. “or” means and/or. For example, “A or B” means A without B, B without A, or A and B. As used herein, “comprising” means including all listed features and potentially including addition of other features that are not listed. “Consisting essentially of” means including the listed features and those additional features that do not materially affect the basic and novel characteristics of the listed features. “Consisting of” means only the listed features to the exclusion of any feature not listed.

Clause 1. A computing device for in silico testing of drugs comprising:

a processing unit;

a memory;

a genomics module configured to receive genomics information of a patient from an external source and provide the genomics information to a classification module;

a drug selection module configured to identify a plurality of drugs to the classification module for testing to determine if one or more drugs from the plurality of drugs that have more than a threshold probability of affecting at least one physical parameter associated with a condition in the patient; and

the classification module, wherein the classification module is configured to identify one or more drugs from the plurality of drugs that have more than the threshold probability of affecting the at least one physical parameter associated with the condition in the patient based at least in part on the genomics information of the patient.

Clause 2. The computing device of clause 1, wherein the plurality of drugs are selected automatically based at least in part on the condition of the patient.

Clause 3. The computing device of clauses 1 or 2, wherein the genomics module obtains genomics information from a cell of the patient exhibiting an effect of the condition.

Clause 4. The computing device of clause 3, wherein the genomics module obtains the genomics information at least partially from a gene expression profile of the patient.

Clause 5. The computing device of any of clauses 1-3 or 4, wherein the classification module uses a classification model learned from a combination of a gene network, functional effects of at least one drug from the plurality of drugs on a previously-treated patient, and genomics information from the previously-treated patient.

Clause 6. The computing device of clause 5, wherein the classification model includes logistic regression.

Clause 7. The computing device of any of clauses 1-5 or 6, wherein the plurality of drugs are represented as a plurality of drug targets, individual ones of the plurality of drug targets indicating a target and a disassociation constant between the drug and the target.

Clause 8. A method of selecting drugs to administer to a patient, the method comprising:

receiving an indication of a condition of the patient;

receiving genomics information of the patient;

receiving a selection of drugs for in silico testing;

providing the condition, the genomics information, and the selection of drugs to a classifier trained with supervised learning to perform the in silico testing; and

receiving, from the classifier, identification of one or more drug treatments from the selection of drugs.

Clause 9. The method of clause 8, wherein the genomics information comprises a gene expression profile of a cell from the patient.

Clause 10. The method of clause 8 or 9, classifying, by a linear classifier, drugs from the selection of drugs as effective or ineffective for affecting at least one physical parameter associated with a condition in a patient.

Clause 11. The method of any of clauses 8, 9, or 10, further comprising training the classifier at least in part by a gene network in which individual genes in the network are represented as n-dimensional vectors.

Clause 12. The method of any of clauses 8-10 or 11, wherein receiving the one or more drug treatments comprises:

receiving, from the classifier, a plurality of drug targets; and

mapping the plurality of drug targets to the one or more drug treatments.

Clause 13. The method of any of clauses 8-11 or 12, wherein the one or more drug treatments comprises at least two drug treatments ordered by a probability of affecting the condition of the patient.

Clause 14. The method of any of clauses 8-12 or 13, further comprising:

obtaining a cell from the patient, the cell exhibiting the condition;

growing the cell in a cell culture;

measuring mRNA expression levels of the cell culture; and

generating at least part of the genomics information from the mRNA expression levels.

Clause 15. The method of clause any of clauses 8-13 or 14, further comprising:

obtaining a cell from the patient, the cell exhibiting the condition;

growing the cell in a cell culture;

separately applying at least two of the drug treatments to the cell culture;

identifying a subset of the drug treatments that affect the cell culture; and

administering at least one drug treatment that is identified as affecting the cell culture to the patient.

Clause 16. A method of identifying a downstream effect of a drug on a gene that is not a direct target of the drug, the method comprising:

identifying a set of gene descriptors that identify a first gene, a second gene, a type of influence between the first gene and the second gene, and a direction of the influence;

generating a gene network that includes the first gene, the second gene, and a plurality of other genes, individual genes in the gene network represented by nodes and relationships between the individual genes represented by edges;

representing information contained in the gene descriptors as a plurality of n-dimensional real vectors;

propagating an effect of the drug on a target gene through the edges of the gene network from the target gene to the gene that is not a direct target of the drug; and

determining a probability of the drug influencing the gene that is not the direct target of the drug.

Clause 17. The method of clause 16, wherein the identifying comprises identifying the set of gene descriptors at least in part from natural language processing of scientific literature.

Clause 18. The method of clause 16 or 17, wherein the determining comprises determining the probability of the drug influencing the gene that is not the direct target of the drug by iteratively simulating a random walk process through the gene network.

Clause 19. The method of clause 16, 17, or 18, further comprising optimizing scores of the set of gene descriptors such that gene descriptors that are in the gene network have higher scores than gene descriptors that are outside the gene network.

Clause 20. The method of any of clauses 16-18 or 19, further comprising grouping a set of genes in a target cluster based at least in part on a shortest path in the gene network between the set of genes.

Conclusion

Although the subject matter has been described in language specific to structural features and/or methodological acts, it is to be understood that the subject matter defined in the appended claims is not necessarily limited to the specific features or acts described above. Rather, the specific features and acts are disclosed as example forms of implementing the claims.

All publications referenced herein are incorporated by reference both for the specific teachings for which the individual publications are cited and for everything disclosed within the referenced publications.

1. A computing device for in silico testing of drugs comprising:
a processing unit;
a memory;
a genomics module configured to receive genomics information of a patient from an external source and provide the genomics information to a classification module;
a drug selection module configured to identify a plurality of drugs to the classification module for testing to determine if one or more drugs from the plurality of drugs that have more than a threshold probability of affecting at least one physical parameter associated with a condition in the patient; and
the classification module, wherein the classification module is configured to identify one or more drugs from the plurality of drugs that have more than the threshold probability of affecting the at least one physical parameter associated with the condition in the patient based at least in part on the genomics information of the patient.

2. The computing device of claim 1, wherein the plurality of drugs are selected automatically based at least in part on the condition of the patient.

3. The computing device of claim 1, wherein the genomics module obtains genomics information from a cell of the patient exhibiting an effect of the condition.

4. The computing device of claim 3, wherein the genomics module obtains the genomics information at least partially from a gene expression profile of the patient.

5. The computing device of claim 1, wherein the classification module uses a classification model learned from a combination of a gene network, functional effects of at least one drug from the plurality of drugs on a previously-treated patient, and genomics information from the previously-treated patient.

6. The computing device of claim 5, wherein the classification model includes logistic regression.

7. The computing device of claim 1, wherein the plurality of drugs are represented as a plurality of drug targets, individual ones of the plurality of drug targets indicating a target and a disassociation constant between the drug and the target.

8. A method of selecting drugs to administer to a patient, the method comprising:
receiving an indication of a condition of the patient;
receiving genomics information of the patient;
receiving a selection of drugs for in silico testing;
providing the condition, the genomics information, and the selection of drugs to a classifier trained with supervised learning to perform the in silico testing; and
receiving, from the classifier, identification of one or more drug treatments from the selection of drugs.

9. The method of claim 8, wherein the genomics information comprises a gene expression profile of a cell from the patient.

10. The method of claim 8, classifying, by a linear classifier, drugs from the selection of drugs as effective or ineffective for affecting at least one physical parameter associated with a condition in a patient.

11. The method of claim 8, further comprising training the classifier at least in part by a gene network in which individual genes in the network are represented as n-dimensional vectors.

12. The method of claim 8, wherein receiving the one or more drug treatments comprises:
receiving, from the classifier, a plurality of drug targets; and
mapping the plurality of drug targets to the one or more drug treatments.

13. The method of claim 8, wherein the one or more drug treatments comprises at least two drug treatments ordered by a probability of affecting the condition of the patient.

14. The method of claim 8, further comprising:
obtaining a cell from the patient, the cell exhibiting the condition;
growing the cell in a cell culture;
measuring mRNA expression levels of the cell culture; and
generating at least part of the genomics information from the mRNA expression levels.

15. The method of claim 8, further comprising:
obtaining a cell from the patient, the cell exhibiting the condition;
growing the cell in a cell culture;
separately applying at least two of the drug treatments to the cell culture;
identifying a subset of the drug treatments that affect the cell culture; and
administering at least one drug treatment that is identified as affecting the cell culture to the patient.

16. A method of identifying a downstream effect of a drug on a gene that is not a direct target of the drug, the method comprising:
identifying a set of gene descriptors that identify a first gene, a second gene, a type of influence between the first gene and the second gene, and a direction of the influence;
generating a gene network that includes the first gene, the second gene, and a plurality of other genes, individual genes in the gene network represented by nodes and relationships between the individual genes represented by edges;
representing information contained in the gene descriptors as a plurality of n-dimensional real vectors;
propagating an effect of the drug on a target gene through the edges of the gene network from the target gene to the gene that is not a direct target of the drug; and
determining a probability of the drug influencing the gene that is not the direct target of the drug.

17. The method of claim 16, wherein the identifying comprises identifying the set of gene descriptors at least in part from natural language processing of scientific literature.

18. The method of claim 16, wherein the determining comprises determining the probability of the drug influencing the gene that is not the direct target of the drug by iteratively simulating a random walk process through the gene network.

19. The method of claim 16, further comprising optimizing scores of the set of gene descriptors such that gene descriptors that are in the gene network have higher scores than gene descriptors that are outside the gene network.

20. The method of claim 16, further comprising grouping a set of genes in a target cluster based at least in part on a shortest path in the gene network between the set of genes.
